(19) United States
(12) Patent Application Publication
(10) Pub. No.: US 2015/0370584 A1
(43) Pub. Date: Dec. 24, 2015

(54) COMPUTER SYSTEM AND PROGRAM

(71) Applicant: HITACHI, LTD., Chiyoda-ku, Tokyo (JP)

(72) Inventor: Yasuhiro ITO, Tokyo (JP)

(73) Assignee: Hitachi, Ltd., Chiyoda-ku, Tokyo (JP)

(21) Appl. No.: 14/650,017

(22) PCT Filed: Jan. 17, 2013
(86) PCT No.: PCT/JP2013/050860

§ 371 Date: Jun. 5, 2015

(51) Int. Cl. G06F 9/455; H04L 29/08

(52) U.S. Cl. CPC G06F 9/455; H04L 67/10

(57) ABSTRACT

Provided is a computer system in which computer environments 0101 and 0102 send replicas 0111 and 0112 of software resources owned by users to a counterpart side, and the software resources are allowed to be executed in a counterpart-side computer environment 0100. In the computer system, authentication of a software-resource use right for restricting usage in conditions other than a predetermined condition is realized by using authentication-query verifying parts 0105 and authentication-query generating parts 0113. Authentication keys are generated based on combination information of software resources that should not be used at the same time at the user sides and the counterpart side, which is caused by software-resource replication, and operation information of software executed at the counterpart side, and the generated authentication keys are exchanged between the counterpart side and the user sides, thereby verifying the appropriateness of usage of the software resources.

### TECHNICAL FIELD

The present invention relates to a computer system, particularly, a system technology used in a development environment for executing a simulation in which a plurality of simulators cooperate.

### BACKGROUND ART

In development of an embedded system, a development environment for executing a complicated simulation in which a plurality of simulators cooperate is required. The embedded system is a system including a mechanism to be controlled, hardware that performs control arithmetic based on the physical quantity received from the mechanism and that outputs a control value to the mechanism, and software that is operated in the hardware. For example, in an embedded system of a car, these components correspond to an engine to be controlled, an electronic device, such as a microcomputer, for controlling the engine, and software to be operated in the electronic device. Because the behavior of the software included in the embedded system depends heavily on the configurations of the mechanism to be controlled and the hardware, the behavior of a combination of the mechanism, the hardware, and the software needs to be analyzed.

In recent years, embedded systems have become complicated due to increased reliability and increased functionality of cars, electronic devices, etc. Therefore, developments are simultaneously conducted at a plurality of sites through specialization and subdivision into respective hardware and software parts, to shorten the duration of development. As the specialization advances, poor performance and specification problems are increasingly found at the time of not only part operation check but also part assembly, and the developments are frequently delayed due to returns at the final stage before shipment of products, thus resulting in worsening of development efficiency, which is a problem. One of prior art documents related to such simultaneous developments at a plurality of sites is Patent Literature 1 filed by this applicant, for example.

### CITATION LIST

### Patent Literature

PTL 1: WO 2011/016327

### SUMMARY OF INVENTION

### Technical Problem

In order to address the above-described problems in the simultaneous developments at a plurality of sites, a performance evaluation and verification method can be used through a mechanism-hardware-software cooperative simulation at the time of design. In conventional art, in order to execute such a cooperative simulation with a plurality of simulators being interconnected, it is necessary to create an execution environment in the computer of each individual, thus causing the following five problems. First, it is difficult to share design files and to manage progress because of the simultaneous developments at a plurality of sites. Second, the cost of manually performing parameter adjustment for an individual simulator and for connections between simulators is increased because it is necessary to connect different simulators. Third, the cost for introduction and maintenance of simulators is high because a plurality of simulators are used. Fourth, the calculation capacity is insufficient to operate a plurality of simulators. Fifth, the risk of information leakage is increased because design files are stored in individual PCs.

One solution to these problems is unification of development environments. One of methods for the unification of development environments is described in Patent Literature 1, which is a patent application filed before by inventors of this invention. In Patent Literature 1, it is possible to provide a user of a single group with a cooperative simulation to be executed in a unified computer environment. On the other hand, embedded-system industries for cars etc. have a hierarchical structure in which a plurality of companies are in charge of components constituting a single product, and an upper-level company (hereinafter, referred to as OEM) that is in charge of system assembly assembles these components.

This hierarchical structure is complicated, and a certain part supplier (hereinafter, referred to as supplier) has a plurality of delivery destinations, in some cases. Such a hierarchical component structure is also applied to a cooperative simulation for the product. However, unlike a component constituting the product, it: is difficult to realize delivery of software (hereinafter, referred to as model) for simulating the operation of that component to the OEM, in terms of protection of technical confidentiality, maintenance of an operation environment, and costs.

In order to address the above-described problem, it is possible to use a structure in which the supplier and the OEM have unified simulation environments in their companies, they are interconnected only when a cooperative simulation needs to be executed, and only data required to execute the cooperative simulation is exchanged. However, in this structure, data exchange between the simulators is performed via the Internet, thus causing a problem in that the throughput of the simulation is limited by the communication delay of the Internet.

An object of the present invention is to provide a computer system and a program that address the above-described problems, that keep secret from users the internal configuration and execution environment of software for simulating the operation of a component of a product, and that address the network delay.

### Solution to Problem

In order to achieve the above-described object, the present invention provides a computer system including: a computer environment of a user A and a computer environment of a user B that are connected to each other via a communication channel and that each have a software resource, in which the computer environment of the user B sends a virtual computer environment that includes a replica of the software resource owned by the computer environment of the user B and a simulation model requested by the user A, to the computer environment of the user A, thereby realizing a cooperative simulation.

Furthermore, in order to achieve the above-described object, the present invention provides a computer system including: a network; a computer environment of a user A that is connected to the network and that has a software resource; and a computer environment of a user B that is connected to the network and that has a software resource, in which the computer environment of the user B includes a virtual-computer generating part that generates a virtual computer environment including a replica of the software resource owned by the computer environment of the user B and a simulation model that the user A requests from the user B; and the computer environment of the user A executes a cooperative simulation by using the virtual computer environment received from the computer environment of the user B and the software resource of the user A.

Furthermore, in order to achieve the above-described object, the present invention provides a program that is executed in a computer environment, the program including: in a computer environment of a user A, receiving, via a network, a virtual computer environment that includes a replica of a software resource of a user B and a simulation model that the user A requests from the user B; executing a cooperative simulation by using the virtual computer environment and a software resource of the user A; and generating an authentication key by using an execution state of the cooperative simulation executed in the computer environment of the user A and a usage situation of the replica of the software resource of the user B.

### Advantageous Effects of Invention

According to the present invention, it is possible to provide a cooperative simulation that prevents abuse and replication of a software resource and that does not cause a reduction in the simulation speed.

### BRIEF DESCRIPTION OF DRAWINGS

FIG. 1 is a diagram showing an example overall configuration of a computer system according to a first embodiment.

FIG. 2A is a diagram showing an example simulation-model configuration of a cooperative-simulation environment.

FIG. 2B is a diagram showing example elements required for simulation execution in the cooperative-simulation environment.

FIG. 3 is a diagram for explaining an example configuration for a cooperative simulation executed across a plurality of companies.

FIG. 4 is a diagram showing example transition states of simulator internal time and real time during a cooperative simulation.

FIG. 5A is a diagram showing an example configuration for a cooperative simulation that is executed across companies by aggregating software resources, according to the first embodiment.

FIG. 5B is a diagram showing an example configuration for a cooperative simulation that is executed across companies by aggregating software resources other than license servers, according to the first embodiment.

FIG. 6A is a diagram showing the first half of a software-resource aggregation method, a cooperative-simulation execution procedure, and a software-resource use-right authentication flow, according to the first embodiment.

FIG. 6B is a diagram showing the second half of the software-resource aggregation method, the cooperative-simulation execution procedure, and the software-resource use-right authentication flow, according to the first embodiment.

FIG. 7 is a diagram showing an example configuration of a virtual computer environment and example connections thereof, according to the first embodiment.

FIG. 8 is a diagram showing an example flow of generating a virtual computer environment and a key authentication program, according to the first embodiment.

FIG. 9 is a diagram showing software-resource classification managed by the computer system of the first embodiment.

FIG. 10 is a diagram showing a specific example process of generating four authentication-key generating/verifying programs, according to the first embodiment.

FIG. 11 is a diagram showing example transaction between an OEM side and a supplier side performed using an authentication key, according to the first embodiment.

FIG. 12 is a diagram showing an example configuration of computer hardware used in the computer system according to the first embodiment.

### DESCRIPTION OF EMBODIMENTS

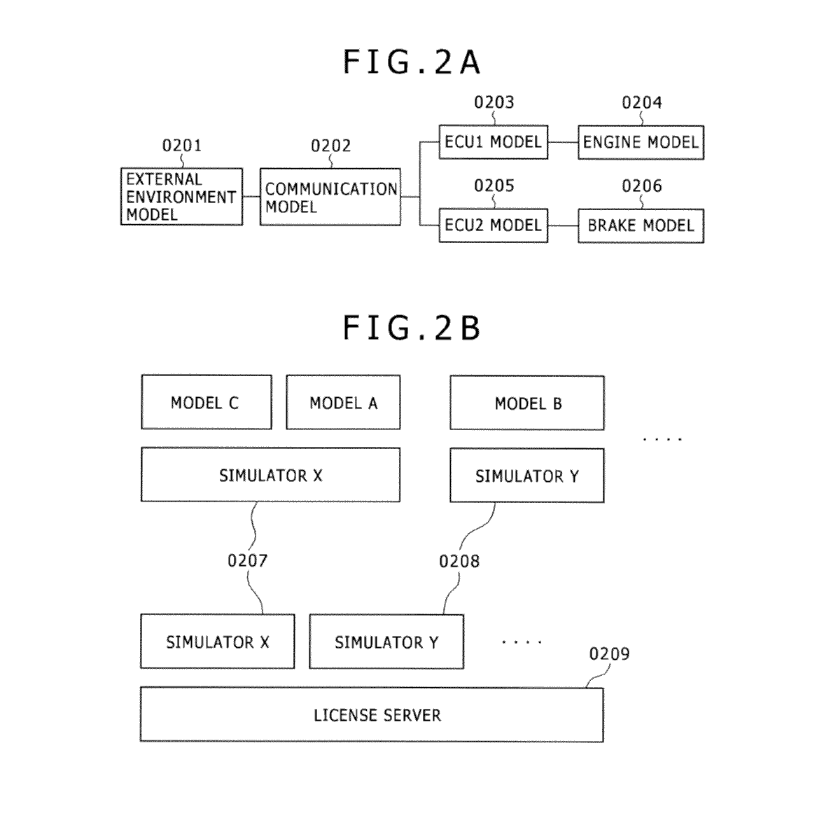

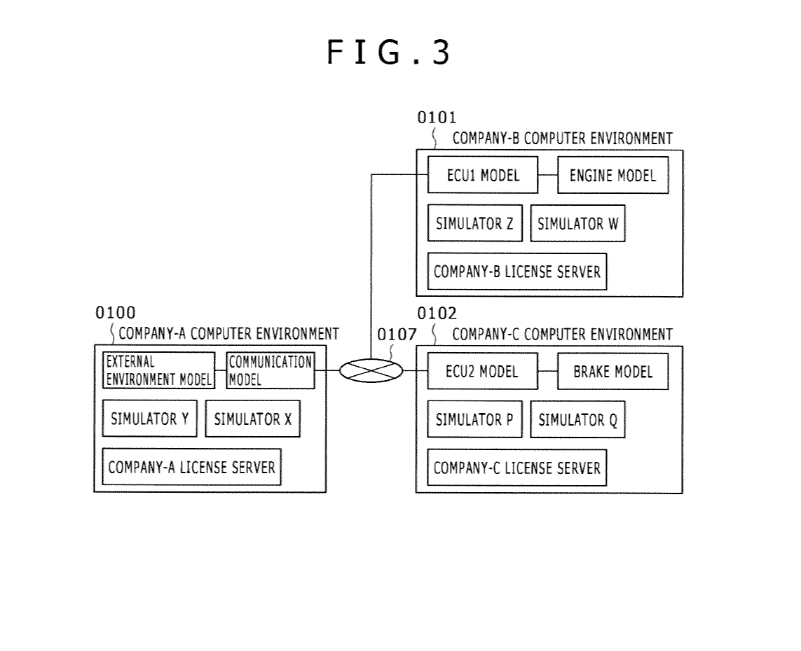

Embodiments of the present invention will be described with reference to the drawings in sequence; however, prior to this, the configuration of a computer system in a cooperative-simulation environment, which is a prerequisite for the present invention, will be described first by using FIG. 2A showing an example model configuration of the cooperative-simulation environment, FIG. 2B showing example elements required for simulation execution in the cooperative-simulation environment, and FIG. 3 schematically showing simulator internal time during a cooperative simulation and an example configuration for a cooperative simulation executed across companies.

FIG. 2A is a diagram showing an example configuration of a cooperative-simulation environment, including a plurality of models, such as ECU (Engine Control Unit) models 0203 and 0205, an engine model 0204, and a brake model 0206. Here, a model means software for simulating the operation of a component of a product, such as a car. For example, in a mechanism-hardware-software cooperative simulation, because simulators that can be used are different depending on the configurations of hardware and mechanisms, such as an engine and a brake, which are simulation targets, and because simulation models that are generated for particular simulators have already been accumulated, a product-level cooperative simulation with different types of simulators being interconnected is executed by using the configuration shown in FIG. 2A.

In such a cooperative simulation, in order to realize a cooperative simulation executed by interconnecting a plurality of simulators that includes an external environment model 201 and a communication model 0202, it is necessary to create an execution environment in the computer of each individual, thus causing the above-described five problems. One solution to these problems is unification of development environments. Because an embedded-system industry has a hierarchical structure in which a plurality of companies are in charge of components constituting a single product, and an OEM assembles these components, a hierarchical component structure is also applied to a cooperative simulation for the product. However, unlike a component constituting the product, it is difficult to realize delivery of a model serving as software for simulating the operation of that component to the OEM, in terms of protection of technical confidentiality and maintenance of an operation environment, as described above.

This is because, in many cases, the internal configuration of the component is implemented in the model in order to reproduce the operation of the component, which is a simulation target, and information that the supplier wants to keep secret can be known by the OEM by examining the delivered model. Furthermore, a model is implemented so as to be operated only in a particular simulator, in many cases, and, in order to execute the model, the OEM requires a model execution environment that is identical to that of the supplier.

FIG. 2B shows example elements that are required for simulation execution. In a cooperative simulation in which models A, B, and C supplied from suppliers a, b, and c are cooperatively operated, when the models A and C are executed in a simulator X 0207, and the model B is executed in a simulator Y 0208, suppliers a and c need to have the license of the simulator X, and the supplier b needs to have the license of the simulator Y. Furthermore, when the OEM executes the cooperative simulation, a license server 0209 needs to have both licenses of the simulators X and Y. This means that, for the OEM, which needs to assemble a variety of models, the cost of creating an environment for the cooperative simulation is increased.

In order to address the above-described problem, it is possible to use a structure in which the suppliers and the OEM have unified simulation environments in their companies, they are interconnected only when the cooperative simulation needs to be executed, and only data required to execute the cooperative simulation is exchanged.

FIG. 3 shows an example configuration having simulators, computers used for execution, and a network therebetween, when this structure is created. In this structure, data is exchanged among simulators X, Y, W, Z, P, and Q in computer environments 0100, 0101, and 0102 of companies A, B, and C via a communication channel 0107 that is a network, such as the Internet. This causes a problem in that the throughput of the simulation is limited by the communication delay of the communication channel 0107, such as the Internet.

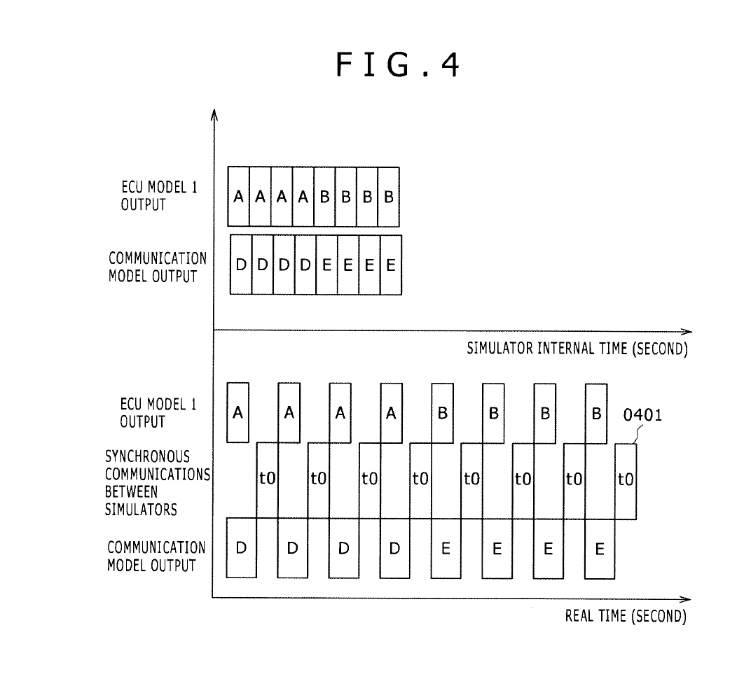

While communications among the simulators depend on the operating accuracy of the simulators, data exchange is performed at about one kilobyte per several milliseconds of simulator execution time, for embedded-system operation verification, in many cases. When two or more simulators cooperate, simulations are executed for a predetermined period (synchronous period), the results obtained at that point are shared, and the simulations are continued, as shown in FIG. 4. Therefore, it is impossible to buffer data to be exchanged between the simulators and collectively send and receive the data and to continue the simulations for the next synchronous period, during a data exchanging period 0401.

The data exchanging period 0401, in which data exchange is performed through synchronous communications between the simulators, corresponds to a zone having a synchronous period t0 shown in FIG. 4, and the length thereof is proportional to a network delay between the simulators. The network delay is approximately proportional to the geographical distance between two connected points. In the case where the two points are geographically separated, a network is built via the Internet unless an exclusive line is used, and the delay thereof becomes at least several hundred milliseconds. Accordingly, a communication delay of several hundred milliseconds is added to the simulator execution time to obtain a simulation execution time of several milliseconds, thereby reducing the simulation speed and allowing only a limited test case to be executed even if a high-speed simulator environment is used.

As described above, in order to address the network communication delay, it is necessary to change the connection structure and to locate computers for executing the cooperative simulation at closer network positions.

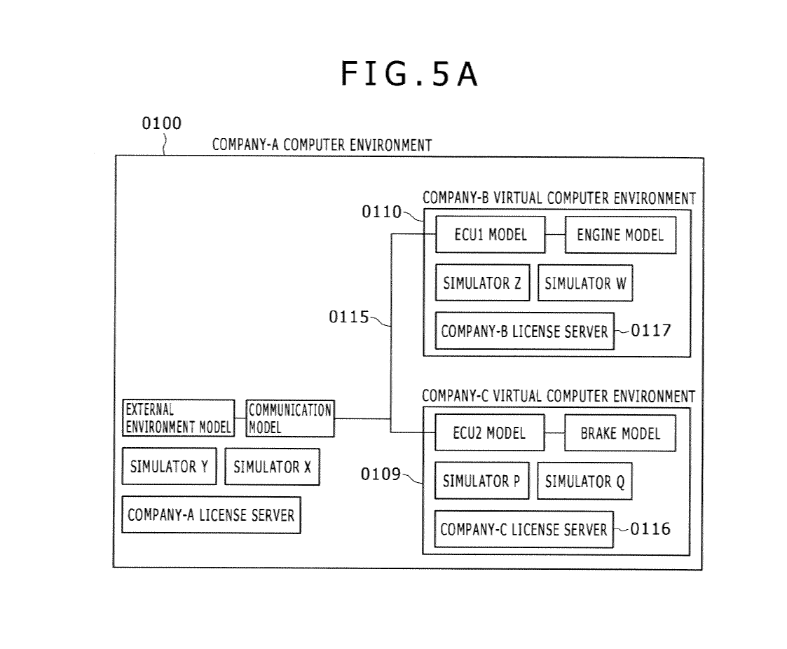

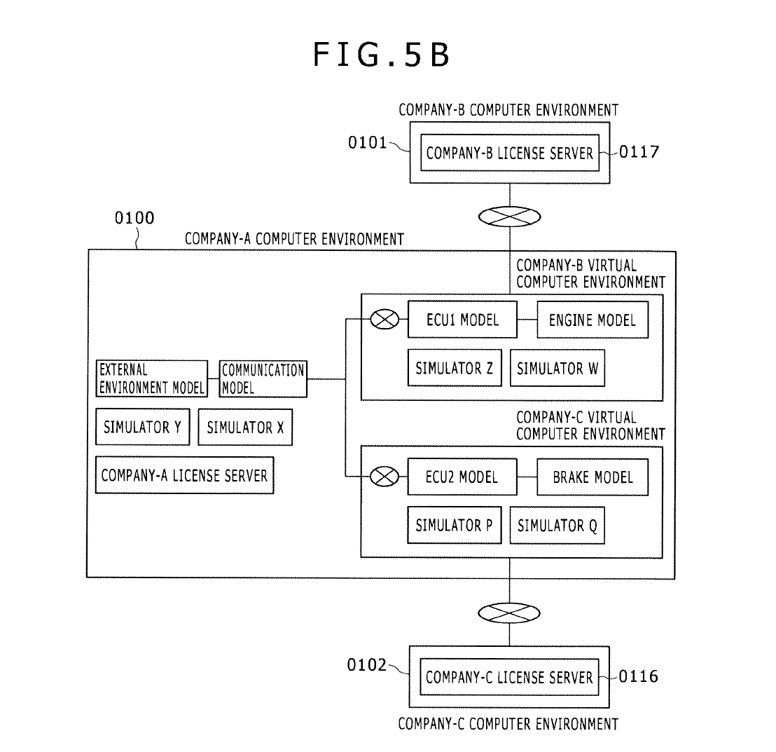

Thus, as shown in FIG. 5A, the following technology can be used: computer systems in which the supplier-side computer environments build computer environments that are required for a cooperative simulation requested by the OEM in virtual computers as the company-B virtual computer environment 0110 and the company-C virtual computer environment 0109 and send them to the company-A computer environment 0100 of the OEM side are combined with a computer system that executes the virtual computers received at the OEM side to execute the cooperative simulation, thereby virtually maintain the logical decoupling of the computer environments between the suppliers and the OEM even though the unified computer environments of the supplier sides are sent to the OEM side.

As a result, with the structure shown in FIG. 5A, because the synchronous communications between the simulators that were performed via the Internet, which causes a long communication delay, can be performed in an OEM-side internal network 0115 in which the physical distances between simulators are short and that causes a small communication delay, it is possible to execute an extremely-high-speed simulation. When this technology Is used, the virtual computers to be exchanged between the suppliers and the OEM include requested models, software groups required to execute the models, and software resources, such as license providing software, for example, a company-B license server 0117 and a company-C license server 0116 that are required to execute the software. Because there is a possibility that these software resources are abused in the OEM-side computer environment, it is necessary to set the virtual computers such that these software resources are operated only for a period of time that the suppliers give permissions.

To prevent abuse, the license servers 0116 and 0117, which provide software licenses, of the software resources owned by the suppliers can be located in supplier's local environments, as shown in FIG. 5B. However, with this configuration, there is fear that requests from simulators to the license servers are executed at intervals of approximately several seconds, which may be affected by the communication delay, and that the software resources are disclosed in response to external accesses, and a means for checking the intended purpose is not provided, which causes a license problem in that unintended use is possible in the OEM side. As a secondary problem, because the software resources that the OEM side is permitted to use are also located at the supplier sides, the supplier sides can freely use them.

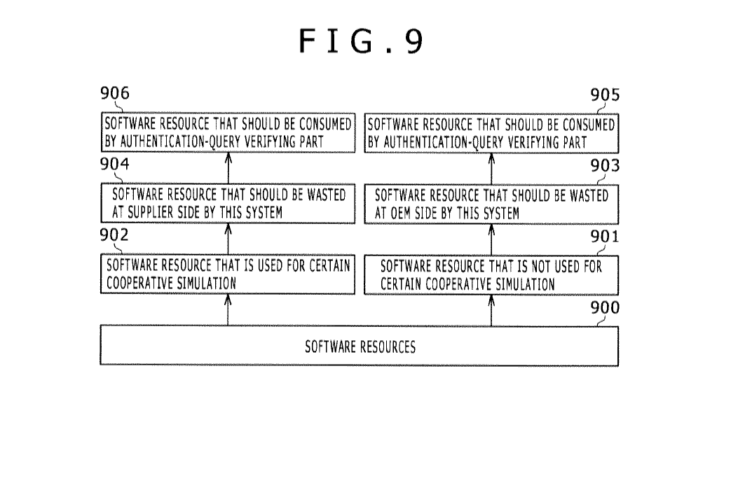

FIG. 9 is a diagram showing software-resource classification managed by the above-described computer system.

First, a certain computer system includes one or more software resources 900. When the user executes a cooperative simulation, the computer system performs calculation by temporarily exclusively using at least one of the software resources. At this time, the software resources 900 are classified into a software resource 902 that is used for the cooperative simulation by the user and a software resource 901 that is not used therefor.

On the assumption that this system is used to grant a license to use a replica of part or whole of a supplier-side software resource to a counterpart of the cooperative simulation, specifically, to the OEM side, the software resource 902, which is used for the cooperative simulation, is a software resource 904 that should be prohibited from being used at the supplier side concurrently with the cooperative simulation, and the software resource 901, which is not used for the cooperative simulation, is a software resource 903 that should be prohibited from being used at the OEM side concurrently with the cooperative simulation.

Since the mechanism for managing a software-resource use right provided by a third party cannot be recreated, it is necessary to appropriately void a target software resource only during the cooperative simulation execution, from outside of the mechanism. Therefore, the software resource 904 has the same meaning as a software resource 906 that should be consumed by a supplier-side authentication-query verifying part that is executed at the supplier side and that will be described later in detail in the embodiment, and the software resource 903 has the same meaning as a software resource 905 that should be consumed by an authentication-query generating part that is executed at the OEM side and that will be described later in detail in the embodiment. This is the computer system for realizing a cooperative-simulation environment, which serves as a computer system according to the embodiment of the present invention, to be described below.

In a preferable aspect of the present invention, the computer environment of the user B, i.e., the supplier side, builds collectively software resources that are required for a cooperative simulation requested by the OEM side, i.e., the user A, in a virtual computer environment and sends a virtual, computer environment file to the computer environment of the user A, and the computer environment of the user A receives the virtual computer environment and executes it.

Furthermore, an authentication key is generated based on combination information of software resources that should not be used at the same time in the computer environments of the user B and the user A, which is caused by software-resource replication, and operation information indicating the operation of software executed in the computer environment of the user A, and the generated authentication key is exchanged between the computer environments of the user B and the user A, thereby authenticating the appropriateness of software-resource use. Execution of the virtual computer is continued only if the authentication successfully ends, and the file forming the virtual computer is deleted from the computer environment of the user A if the authentication ends in failure.

Furthermore, the key authentication Is performed by using a software resource that should be prohibited from being used in the computer environment of the user B concurrently with the cooperative simulation and a software resource that should be prohibited from being used in the computer environment of the user A concurrently with the cooperative simulation, thereby making it possible to grant the license to use a software resource only during a permitted period of time and to void software resources that are included in both of the computer environment of the user A and the computer environment of the user B.

The embodiment of the present invention will be described below with reference to the drawings. In the following description, software to be executed at a processing part in each computer environment is called using program, part, or function. For example, an authentication-query generating program, an authentication-query generating part, or an authentication-query generating function are used. Furthermore, in the following description, although a computer system for realizing a cooperative simulation is realized by connecting computer environments of a plurality of business companies, for example, the company A, the company B, and the company C, via a network, such as the Internet, the computer environment of the company A may be referred to as the computer environment of the user A, and the computer environment of another company, such as the company B or the company C, may be referred to as the computer environment of the user B, for convenience sake.

### Example 1

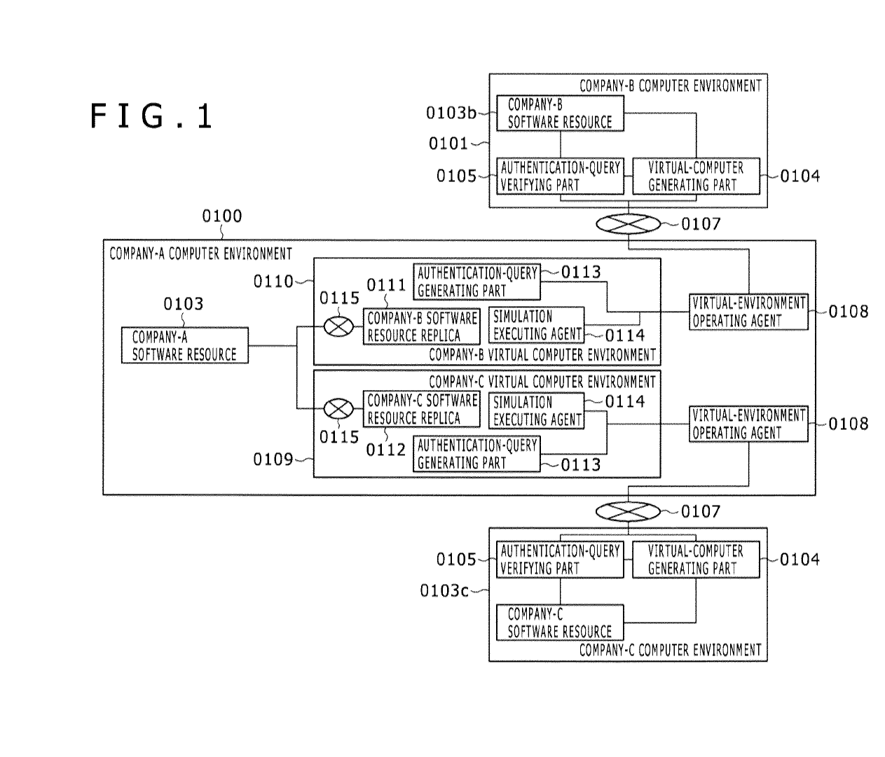

FIG. 1 shows an example overall configuration of a computer system according to a first embodiment.

The computer system of the first embodiment is a computer system for realizing a cooperative simulation in which software resources owned by a plurality of business companies or a plurality of remote sites that are connected via a communication channel, such as the Internet or an exclusive line, are used between the business companies or the remote sites. This embodiment is of a computer system including: a computer environment of a user A and a computer environment of a user B that are connected to each other via a communication channel and that each have a software resource, in which the computer environment of the user B sends a virtual computer environment that includes a replica of the software resource owned by the computer environment of the user B and a simulation model requested by the user A, to the computer environment of the user A, thereby realizing a cooperative simulation.

FIG. 1 shows an example configuration in the case where the company A uses software resources of the company B and the company C to execute a cooperative simulation across the three companies. In FIG. 1, reference numerals 0100, 0101, and 0102 denote computer environments of the company A, the company B, and the company C, and reference numeral 0107 denotes communication channels. In this system configuration, the company B and the company C are referred to as suppliers because they provide software resources for the company A, and the company A is referred to as an OEM because the company A aggregates the software resources of the company A, the company B, and the company C to perform the cooperative simulation. Although the company B and the company C have different types of software resources to be provided for the company A, they use identical components of this system. Furthermore, because switching occurs between the OEM side and the supplier side by changing the content or the subject of the simulation, the company B and the company C can have the same system configuration as the company A, and vice versa. In the following description, the company A is assumed to be a master user that is the subject to execute the cooperative simulation, and the company B and the company C are assumed to be slave users that are in subordinate positions in the cooperative simulation.

Note that it is needless to say that the computer environments of the company A, the company B, and the company C, which constitute this computer system, can be realized by normal computers. As described above, the computer environment of the company A is the computer environment of the user A, and the computer environment of the company B or the company C is the computer environment of the user B.

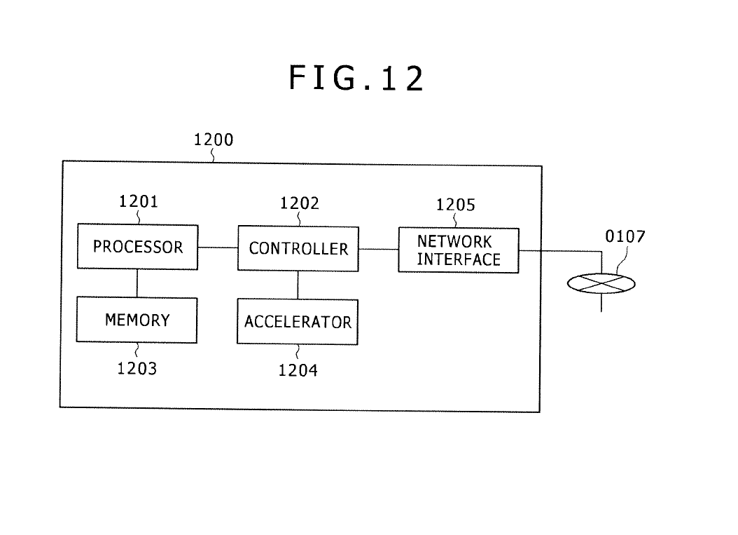

FIG. 12 shows an example computer configuration for realizing such a computer environment. As shown in FIG. 12, a processor 1201 that is a processing part in a computer 1200, a controller 1202, a memory 1203 that is a storing part for storing data and programs, and an accelerator 1204 are connected to a network interface 1205 via an internal bus, and the network interface 1205 is connected to the communication channel 0107, such as the Internet. Furthermore, as in normal computers, an external storage device for accumulating various types of databases (DB), to be described later, and input/output parts, such as a display and a keyboard, can be added as needed. In this specification, unless otherwise noted, the processor 1201 of the computer 1200 processes various programs, thereby realizing a computer environment and a virtual computer environment, to be described later.

As described above, in the computer system of this embodiment, the supplier sides aggregate software resources required for the cooperative simulation in virtual computer environments and send them to the OEM side, and the cooperative simulation is executed in the OEM-side computer environments 0101 and 0102. Thus, in the OEM-side computer environment 0100, the software resource of the OEM and the virtual computer environments 0109 and 0110 of the suppliers are connected via internal networks 0115. The virtual computer environments 0109 and 0110 of the suppliers are connected to the supplier-side computer environments 0101 and 0102 by virtual-environment operating agents 0108 in the OEM-side computer environment 0100 by using the communication lines 0107.

As is clear from FIG. 1, the virtual computer environments 0109 and 0110 of the suppliers include software resource replicas 0111 and 0112 that are connected to the OEM-side software resource 0103 via the internal networks 0115; simulation execution agents 0114 that control the cooperative simulation, which uses supplier-side software resources, in other words, that activate part of the cooperative simulation; and authentication-query generating parts 0113 that perform authentication of the software-resource use rights, with the supplier sides.

On the other hand, the supplier-side computer environments 0101 and 0102 include virtual-computer generating parts 0104 that generate virtual computer environments to be sent to the OEM-side computer environment 0100; authentication-query verifying parts 0105 that perform authentication of the software-resource use rights, requested by the OEM side; and software resources 0103b and 0103c that are the original software resources to be replicated in the virtual computer environments 0110 and 0109 to be sent to the OEM side.

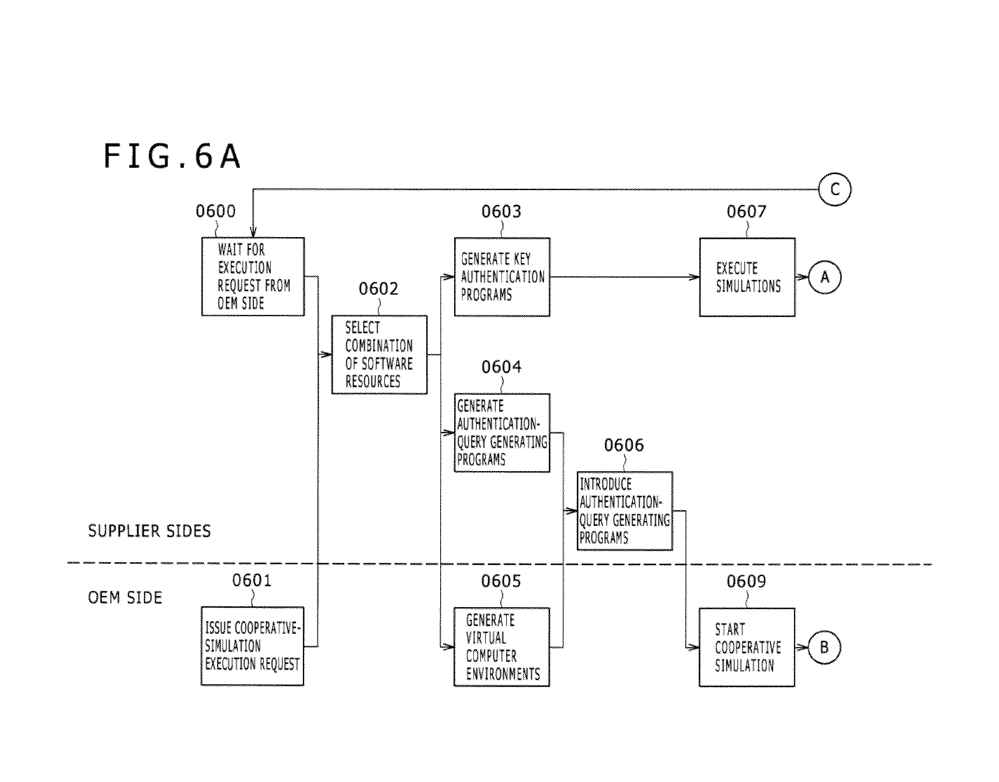

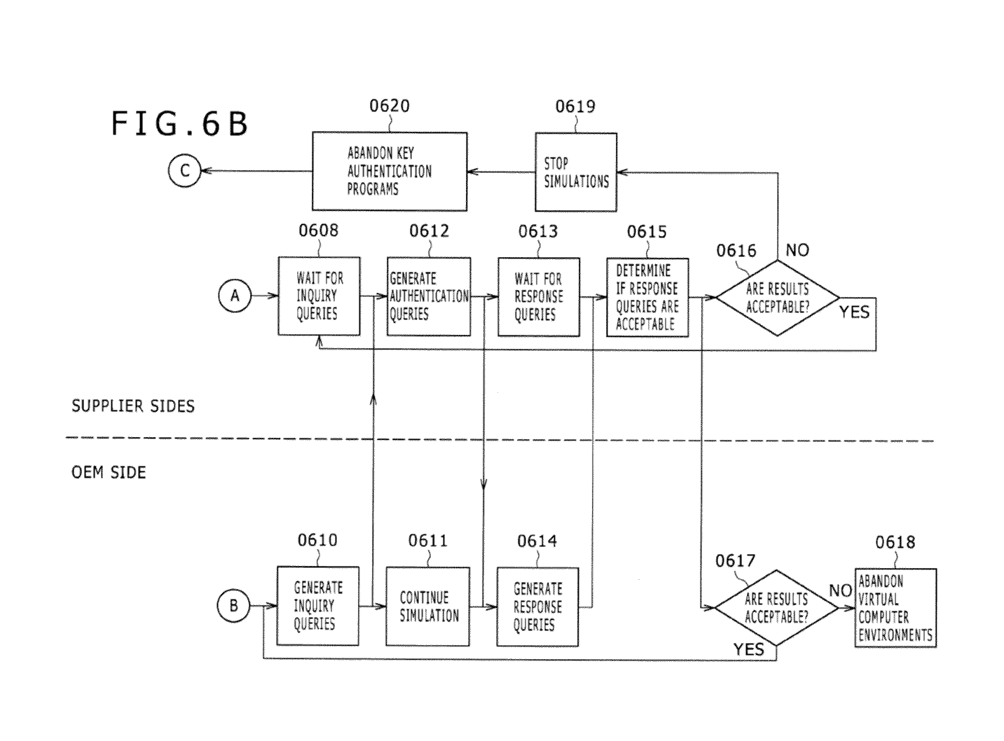

Next, the flow of a cooperative simulation and key authentication managed by the computer system of this embodiment will be described by using FIGS. 6A and 6B.

In FIGS. 6A and 6B, Steps 0600 to 0608, 0612 to 0613, 0615 to 0616, and 0619 to 0620 are executed in the supplier-side computer environments 0101 and 0102, and Steps 0601, 0609 to 0611, 0614, and 0617 to 0618 are executed in the OEM-side computer environment 0100. Note that FIGS. 6A and 6B show the flow by dividing it into the first half and the second half, for the sake of convenience, and are connected at circles A, B, and C.

First, in the initial state corresponding to Step 0600, the supplier-side computer environments 0101 and 0102 wait for a cooperative-simulation execution request from the OEM-side computer environment 0100. Note that, in this embodiment, it is assumed that a combination of models used to execute a cooperative simulation is determined in advance between the OEM and the suppliers, and an identifier is uniquely assigned in advance to the combination of models used for a certain cooperative simulation.

Next, in Step 0610, the OEM side issues a cooperative-simulation execution request to one or a plurality of suppliers. When the cooperative-simulation execution request is received by the supplier-side computer environments 0101 and 0102, the supplier-side computer environments 0101 and 0102 advance to Step 0602. The supplier-side computer environments analyze the content of the received cooperative-simulation execution request and obtain the above-described identifier, which is described in the request and which corresponds to the combination of models used for the cooperative simulation. Then, the supplier-side computer environments obtain the combination of models used for the cooperative simulation, based on the identifier. Based on this information, Steps 603, 604, and 605 are executed.

In Step 603, the authentication-query verifying parts 0105, which are operated in the supplier-side computer environments 0101 and 0102, are generated as simulation models that use all software resources that are used for the cooperative simulation. Next, in Step 604, the authentication-query generating parts 0113, which are operated at the OEM side, are generated as simulation models requested by the OEM side and as simulation models that uses all software resources that are not used for the cooperative simulation, specifically, the difference between software resources that are introduced in the OEM-side computer environment 0100 and a set of the software resources that are used for the cooperative simulation.

The authentication-query generating parts, which are operated in the OEM-side computer environment, generate authentication keys by using replicas of the software resources of the user B that are not used for the cooperative simulation executed in the computer environment of the user A. On the other hand, the authentication-query verifying parts, which are operated in the supplier-side computer environments, perform verification by using part or whole of the suppliers' software resources that are used for the cooperative simulation executed in the OEM-side computer environment.

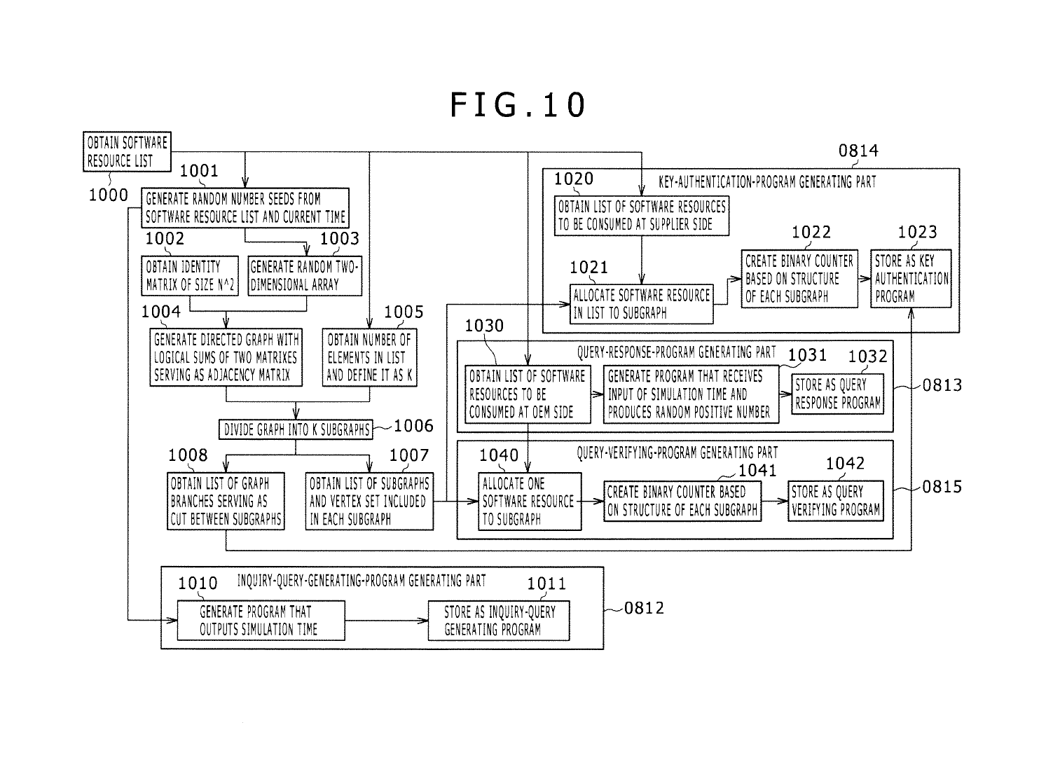

In Step 0605, virtual computer environments in which all models used for the cooperative simulation can be operated and in which all the software resources are introduced are generated. Alternatively, if virtual computer environments that have already been generated are cached, those virtual computer environments are used. In the next Step 606, the authentication-query generating parts 0113, generated in Step 604, are introduced in the virtual computer environments generated in Step 0605, and the thus-obtained virtual computer environments are sent to the virtual-computer-environment operating agents 0108 in the OEM-side computer environment 0100. A specific implementation example of the above-described five steps will be described later in detail by using FIG. 10.

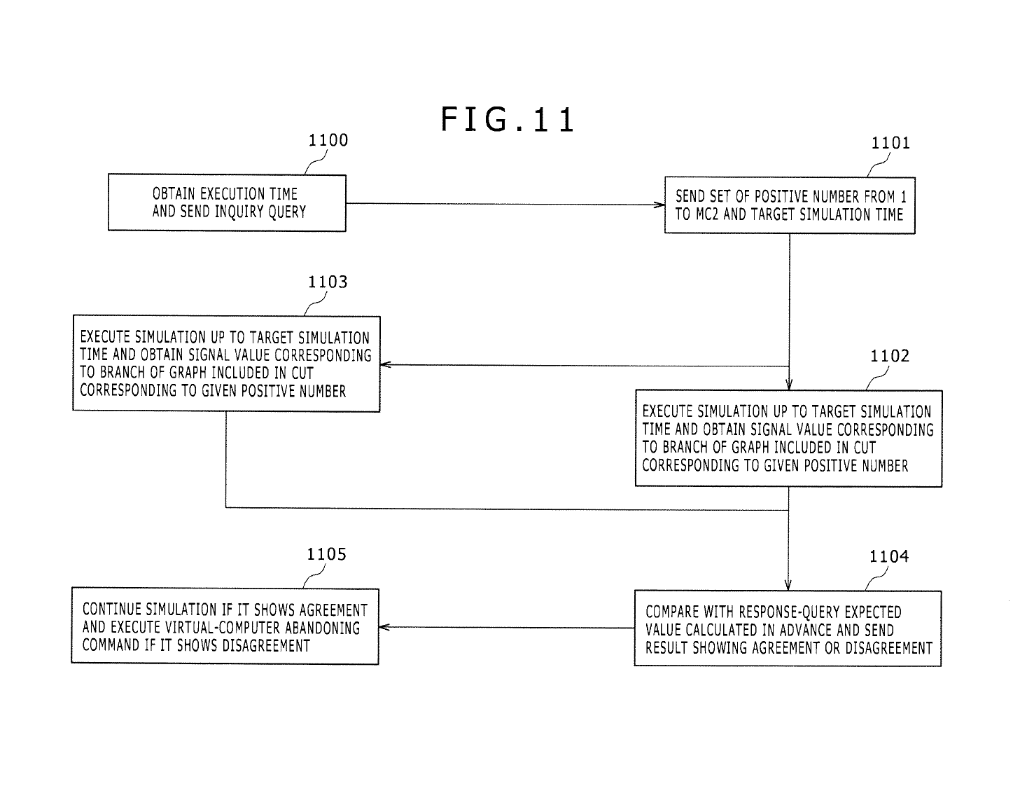

In FIGS. 6A and 6B, the following steps are executed in parallel with the execution of the cooperative simulation at the OEM side. A specific flow using authentication-key implementation corresponding to Steps 0607 to 0618 will be described later in detail by using FIG. 11. In Step 0607, the supplier-side computer environments 0101 and 0102 start simulations using the authentication-query verifying parts 0105, generated in Step 0603. Then, the supplier-side computer environments 0102 and 0102 wait for inquiry queries from the OEM-side computer environment 0100 (Step 0608).

At the same time, in the OEM-side computer environment 0100, when the virtual computer environments used to execute the cooperative simulation, which are sent from the supplier-side computer environment 0101 in Step 0606, have been received, the virtual-environment operating agents 0108 start executing the received virtual computer environments 0109 and 0110. By using the start of the virtual computer environments as triggers, the simulation execution agents 0114 are activated to start the supplier-side models for the cooperative simulation, and, because an OEM-side model for the cooperative simulation has already been activated in Step 0601 to wait for responses from the supplier-side models, the cooperative simulation is automatically started, and data recording is started (Step 0609).

At the same time as the start of the cooperative simulation, the virtual-environment operating agents 0108 activate the authentication-query generating parts 0113. The authentication-query generating parts 0113 generate certain-length bit strings based on the simulation execution time and identifiers of the virtual computer environments, at fixed simulation-time intervals determined when the authentication-query generating parts 0113 are generated, and send the bit strings to the authentication-query verifying parts 0105 of the supplier-side computer environments 0101 and 0102 as inquiry queries (Step 0610).

After sending the inquiry queries, the authentication-query generating parts 0105 wait for authentication queries to be sent from the OEM-side computer environment 0100, and, in the meantime, the cooperative simulation in the OEM-side computer environment 0100 is continued (Step 0611).

When the supplier-side authentication-query verifying parts 0105 that have been waiting for inquiry queries since Step 0608 receive the inquiry queries, the authentication-query verifying parts 0105 generate certain-length bit strings based on the simulation execution time etc. included in the inquiry queries and sends the bit strings to the authentication-query generating parts 0113 in the OEM-side computer environment 0100 as authentication queries (Step 0612). After sending the authentication queries, the supplier-side authentication-query verifying parts 0113 wait for response queries to be sent from the OEM-side computer environment 0100 (Step 0613).

When receiving the authentication queries, the authentication-query generating parts 0113 in the OEM-side computer environment 0100 extract internal states from the simulation models forming the authentication-query generating parts 0113, based on information included in the authentication queries, and send the internal states to the authentication-query verifying parts 0105 in the supplier-side computer environments as response queries (Step 0614).

In the supplier-side computer environments 0101 and 0102, when the authentication-query verifying parts 0105 receive the response queries, the authentication-query verifying parts 0105 compare the internal states of the simulation models included in the queries with the internal states of the simulation models included in the authentication-query verifying parts 0105 and determine whether the results have expected values. The determination results are sent to the virtual-environment operating agents 0108 in the OEM-side computer environment 0100 (Step 0615 and Step 0616).

If the determination results received by the virtual-environment operating agents 0108 in the OEM-side computer environment 0100 are acceptable, the cooperative simulation is continued, and the authentication flow returns to Step 0610 and is repeated again from Step 0610, where inquiry queries are generated. If the determination results are unacceptable, it is determined that the licenses have been abused, and the virtual-environment operating agents 0108 abandon the virtual computer environments 0109 and 0110, which are executing the cooperative simulation, and force-quit the cooperative simulation.

When the cooperative simulation has already completed, the Inquiry queries generated in Step 0610 have invariable values, thereby determining the results of the authentication flow to be unacceptable and abandoning the virtual computer environments. Therefore, at the end of the first cooperative simulation, the virtual computer environments 0109 and 0110, which are sent from the supplier sides, are deleted from the OEM-side computer environment 0100 regardless of the results. To abandon the virtual computer environments, a method using the function of a virtual OS (Operating System) manager, which is used to create a virtual computer environment, or a method for breaking down a file system in a virtual computer environment can be used, and this system can use either method.

Furthermore, if it is determined at the supplier sides that the results of the authentication flow are acceptable in Step 616, the cooperative simulation is continued, and the key authentication flow also needs to be continued; therefore, the flow returns to Step 0608 to wait for inquiry queries again. If the results are unacceptable, the simulations included in the authentication-query verifying parts 0105 that are currently executed in the supplier-side computer environments are stopped (Step 0619). Then, the authentication-query verifying parts 0105, which are generated for this cooperative simulation, are abandoned, and the flow returns to Step 600 to wait for a cooperative simulation request from the OEM side.

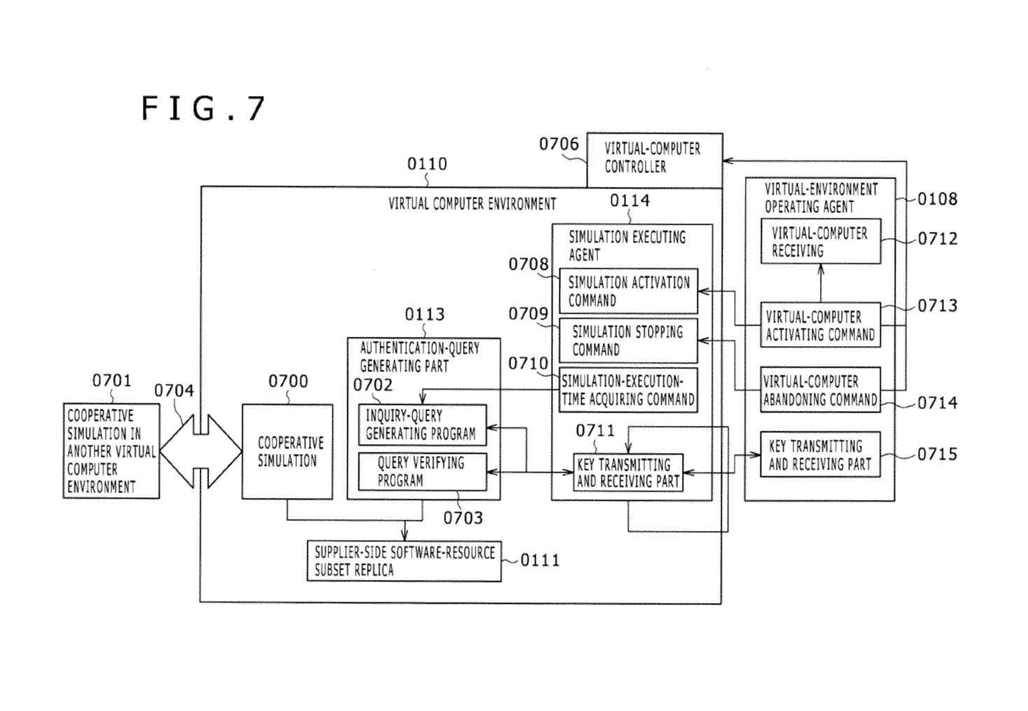

FIG. 7 is a diagram showing the details of an example internal structure of each of the virtual computer environments 0109 and 0110, which are sent to the OEM-side computer environment 0100, and a connection relation thereof, in the computer system of this embodiment shown in FIG. 1.

In the OEM-side computer environment 0100, one or more virtual-environment operating agents 0108, whose number corresponds to the number of suppliers that execute the cooperative simulation together with the OEM, are first introduced. Each of the virtual-environment operating agents 0108 is composed of the following four components.

Specifically, the four components are: a virtual-computer receiving part 0712 that receives a virtual computer environment sent from the supplier side; a virtual-computer activating command 0713 that activates the virtual computer environment after it is received by the virtual-computer receiving part; a key transmitting and receiving part 0715 that exchanges a key with the supplier-side computer environment when key authentication is performed therebetween; and a virtual-computer abandoning command 0714 that stops a simulation executed in the virtual computer environment and abandons the virtual computer environment, upon reception of a request from the key transmitting and receiving part 0715.

Because the virtual-computer activating command 0713 and the virtual-computer abandoning command 0714 perform virtual-machine starting and stopping and abandoning of the file forming the virtual computer, they are connected to a virtual-computer controller 0706 that manages the operation of the virtual computer environment. Note that the function of existing virtual-computer software can be directly used as the virtual-computer controller 706.

The virtual computer environment 0110 includes the simulation execution agent 0114, the authentication-query generating part 0113, a replica 0111 of the whole or a subset of supplier-side software resources, and a supplier-side cooperative simulation 0700.

The cooperative simulation 0700 is connected to a cooperative simulation 0701 in OEM or another supplier virtual computer by using an inter-simulator interface 0704.

The authentication-query generating part 0113 is composed of an inquiry-query generating program 0702 and a query verifying program 0703. The inquiry-query generating program 0702 receives an output from a simulation-execution-time acquiring command 0710 of the simulation execution agent 0114, generates an inquiry query, and sends the inquiry query to a key transmitting and receiving part 0711 of the simulation execution agent 0114. Furthermore, the query verifying program 0703 receives an authentication query sent from the key transmitting and receiving part 0711, generates a response query by using the state in the query verifying program 0703, and sends the response query to the key transmitting and receiving part 0711.

Note that the supplier-side cooperative simulation 0700, and the inquiry-query generating program 0702 and the query verifying program 0703, which constitute the authentication-query generating part 0113, are all simulator programs that are operated using the replica of the whole or the subset of the supplier-side software resources. In particular, the authentication-query generating part 0113 uses the replica of the supplier-side software resource that is not used for the cooperative simulation executed in the OEM-side computer environment 0100, thereby making it possible to inhibit the user at the OEM side from abusing the supplier-side software resources.

The simulation execution agent 0114 is a component that controls the operations of the supplier-side cooperative simulation 0700 and the authentication-query generating part 0113 and is composed of the following three components.

A simulation activating command 0708 works with the virtual-computer activating command 0713 of the virtual-environment operating agent 0108 and is started to be executed by using activation of this virtual computer environment as a trigger. Specifically, when the virtual computer environment is executed, execution of the cooperative simulation is automatically started.

A simulation stopping command 0709 works with the virtual-computer abandoning command 0714 of the virtual-environment operating agent 0108 and is implemented in order to safely stop the cooperative simulation 0700 before the virtual computer environment 0110 is destructed.

The simulation-execution-time acquiring command 0710 is a program that outputs the simulation execution time to be used by the inquiry-query generating program 0702 and can obtain execution time of the cooperative simulation managed by one or all of the simulators that execute the supplier-side cooperative simulation 0700 or the inter-simulator interface, which manages the simulators.

These are the functions of the components constituting the simulation execution agent 0114.

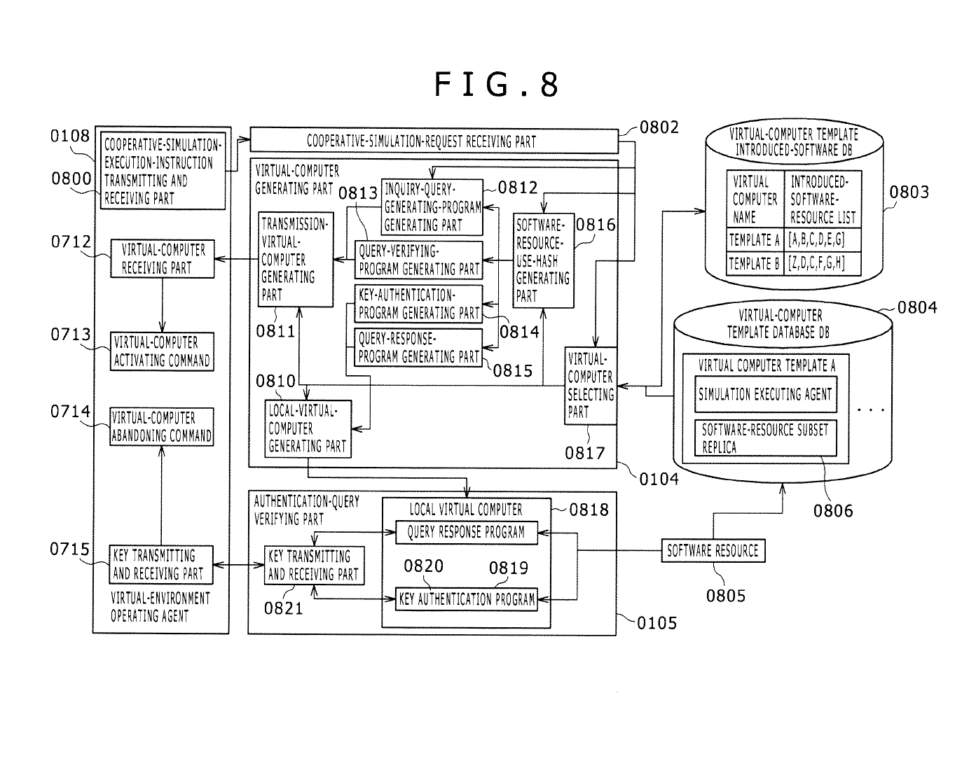

Next, a specific example configuration of each of the supplier-side computer environments 0101 and 0102 shown in FIG. 1 will be described by using FIG. 8.

FIG. 8 shows an example detailed configuration of the authentication-query verifying part 0105 and the virtual-computer generating part 0104 included in each of the supplier-side computer environments 0101 and 0102 and shows connections to the OEM-side computer environment 0100.

As is clear from FIG. 8, the supplier-side computer environments 0101 and 0102 each include a cooperative-simulation-request receiving part 0802, the virtual-computer generating part 0104, the authentication-query verifying part 0105, a supplier-side software resource 0805, a virtual-computer template database (DB) 0804, and a virtual-computer template introduced-software DB 0803. Note that the supplier-side software resource 0805 corresponds to the above-described software resource 103b or 103c.

The cooperative-simulation-request receiving part 0802 receives a cooperative-simulation execution request sent from a cooperative-simulation-execution-instruction transmitting part 0800 of the OEM-side virtual-environment operating agent 0108, extracts the identifier of the cooperative simulation to be executed, the identifier being described in this query, and outputs the identifier to the virtual-computer generating part 0104.

The virtual-computer generating part 0104 has the function of generating a virtual computer environment that can realize the cooperative simulation desired by the OEM-side computer environment 0100 and further generating programs that authenticate a software use right. The virtual-computer generating part 0104 is composed of 10 components including two databases.

First, a software-resource-use-hash generating part 0816 receives the identifier of a cooperative-simulation configuration desired by the OEM, the identifier being output by the cooperative-simulation-request receiving part 0802, and generates a certain-length bit string that is called a software-resource use hash value.

On the other hand, a virtual-computer selecting part 0817 generates a software set required to execute the cooperative simulation based on the identifier of the cooperative-simulation configuration desired by the OEM. The virtual-computer selecting part 0817 searches the virtual-computer template introduced-software DB 0803 based on a value of the set. Then, the virtual-computer selecting part 0817 searches for data in which an introduced software group completely includes the value of the set, the data being included in the virtual-computer template introduced-software DB 0803, and obtains the corresponding virtual-computer template name.

Next, the virtual-computer selecting part 0817 searches the virtual-computer template DB 0804 by the obtained virtual-computer template name and obtains the corresponding virtual-computer template. If the corresponding virtual-computer template is not found, the virtual-computer selecting par. 0817 generates a virtual computer environment that includes the whole software required to execute the cooperative simulation, adds data to the virtual-computer template DB and the virtual-computer template introduced-software DB 0803, and uses the new virtual computer environment.

Two copies of the obtained virtual-computer template are taken, one of them is output to a transmission-virtual-computer generating part 0811, and the other is output to a local-virtual-computer generating part 0810.

The virtual-computer template DB 0804 is a database for storing files forming virtual computers that serve as templates of virtual computers used for cooperative simulations and key authentication. A unique identifier is assigned to the template of each virtual computer and is stored in the database together with the entity of the virtual-computer forming file or a file path thereof. One or more software resources and one simulation execution agent are introduced in the template of each virtual computer.

An inquiry-query-generating-program generating part 0812 generates an inquiry-query generating program by using the cooperative simulation request and the software-resource use hash value and sends it to the transmission-virtual-computer generating part 0811.

A query-verifying-program generating part 0813 generates a query verifying program by using the software-resource use hash value and sends it to the transmission-virtual-computer generating part 0811.

A key-authentication-program generating part 0814 generates a key authentication program by using the software-resource use hash value and sends it to the local-virtual-computer generating part 0810.

A query-response-program generating part 0815 generates an inquiry-query response program by using the software-resource use hash value and sends it to the local-virtual-computer generating part 0810.

An operation flow of the above-described four components will be described later in detail by using FIG. 10.

The transmission-virtual-computer generating part 0811 generates the authentication-query generating part by inserting the inquiry-query generating program and the query verifying program into the virtual-computer template generated by the virtual-computer generating part 0104 and sends it to the virtual-computer receiving part 0800 in the virtual-environment operating agent 0108 of the OEM-side computer environment 0100.

The local-virtual-computer generating part 0810 inserts the key authentication program 0819 and the query response program 0820 into the virtual-computer template generated by the virtual-computer generating part 0104, sends it to the authentication-query verifying part 0105 as a local virtual computer 0818, and starts execution.

The key authentication program 0819 and the query response program 0820 are operated as simulation programs using software resources and exchange an authentication key with the OEM-side computer environment 0100 via a key transmitting part 0821.

FIG. 10 is a diagram showing a specific example process of generating four authentication-key generating/verifying programs that can be used in the authentication flow described in FIG. 8.

This process is divided into five components and includes Steps 1000 to 1008 that correspond to a key-generation common stage for generating items to be used in common by the four programs, Steps 1010 and 1011 that correspond to the inquiry-query-generating-program generating part 0812, Steps 1020 to 2023 that correspond to the key-authentication-program generating part 0814, Steps 1030 to 1033 that correspond to the query-response-program generating part 0815, and Steps 1040 to 1042 that correspond to the query-verifying-program generating part 0813.

Note that, in the computer system of this embodiment, instead of the process of generating programs for authentication-key generation etc., shown in FIG. 10, it is possible to use any internal implement or flow as long as it has a configuration for performing any existing code encoding/decoding process by using four programs that enable key generating/verifying, implemented in a simulator. The steps shown in FIG. 10 will be sequentially described below.

### (Step 1000)

A list of software resources that are introduced in the virtual computers used for the cooperative simulation at the OEM side is obtained from the virtual-computer template introduced-software DB 0803. This list is defined as L.

### (Step 1001)

A plurality of random-number seeds to be used in common in the following steps are generated based on the obtained list L and the current time.

### (Step 1002)

A natural number N (128<N<1024) is generated by using one random-number seed value. A matrix of size N×N is defined, and the elements of the matrix are selected randomly from 0, 1, and 2 and are initialized.

### (Step 1003)

An identity matrix of size N×N is defined.

### (Step 1004)

The logical sums of the elements of the matrixes generated in Steps 1002 and 1003 are obtained to acquire one matrix R. Then, a directed graph G with N vertexes is defined with this matrix R serving as an adjacency matrix.

### (Step 1005)

The number of elements in the list L is defined as K.

### (Step 3006)

The directed graph G is divided into K subgraphs.

### (Step 1007)

A list of the subgraphs and a vertex set included in each of the subgraphs are obtained and defined as SL and VSL, respectively.

### (Step 1008)

A set of edges each connecting two vertexes included in different subgraphs is defined as a cut, and a list of cuts among the subgraphs is defined as KL. By using SL, VSL, KL, N, and L defined in the above-described common steps, the key generating/verifying programs are actually generated in the following steps.

### (Step 1010)

In the inquiry-query-generating-program generating part 0812, a program for outputting a counter circuit that overflows at the time corresponding to the random-number seed value and for outputting simulation time at the time of the overflow is generated.

### (Step 1011)

A program in which the program generated in Step 1010 is implemented in an appropriate software resource included in L is stored as the inquiry-query generating program.

### (Step 1020)

In the key-authentication-program generating part 0814, a list of software resources that are included in the list and that should be consumed at the supplier side is obtained and defined as L1.

### (Step 1021)

An association list in which one software resource included in L1 is associated with one or more elements in SL is generated and defined as AL0.

### (Step 1022)

Binary counters in each of which a vertex set included in each element in VSL, is regarded as a bit, and a directional branch between vertexes included in the same VSL is regarded as wiring are created and are generated as simulation models to be operated in the corresponding software resources in AL0. Cut portions in the graph G, specifically, directional branches across the elements in VSL, are regarded as interface connections between simulations, and connections are made.

### (Step 1023)

A program in which the plurality of simulation models created in Step 1022 are connected through inter-simulator connections is stored as the key authentication program.

### (Step 1030)

In the query-response-program generating part 0813, a list of software resources that are included in the list and that should be consumed at the OEM side is obtained and defined as L2, and the number of elements therein is defined as M.

### (Step 1031)

A program that receives an input of the simulation time to randomly produce a positive number from 1 to M(M−1)/2 is generated.

### (Step 1032)

A program in which the program generated in the previous step is implemented in an appropriate software resource included in L2 is stored as the inquiry-query response program.

### (Step 1040)

In the query-verifying-program generating part 0815, M elements are randomly extracted from the elements in SL and are defined as SSL. An association list AL1 in which one software resource included in L2 is associated with each element in SSL is generated.

### (Step 1041)

Binary counters in each of which a vertex set included in each element in SSL is regarded as a bit, and a directional branch between vertexes included in the same SSL is regarded as wiring are created and are generated as simulation models to be operated in the corresponding software resources in AL1. Cut portions in the graph G, specifically, directional branches across the elements in SSL, are regarded as interface connections between simulations, and connections are made.

### (Step 1042)

A program in which the plurality of simulation models created in Step 1041 are connected through inter-simulator connections is stored as the query verifying program.

FIG. 11 shows example transaction between the OEM side and the supplier side, performed using the authentication key generated in FIG. 10.

### (Step 1100)

Execution time is obtained when the counter, which is introduced in advance in the inquiry-query generating program, overflows and is sent to the key transmitting and receiving part as an inquiry query. The counter that has overflowed continuously keeps incrementing as long as the cooperative simulation is continued. Thus, the process starting from Step 1100 is executed at a constant frequency during the execution of the cooperative simulation.

### (Step 1101)

When the query response program receives the inquiry query, an authentication-query generating function in the query response program is triggered. A constant number M is defined in the authentication-query generating function when this function is generated. The value of the constant number M corresponds to the above-described number of software resources that should be consumed at the OEM side.

The authentication-query generating function uses the simulation execution time in the received inquiry query as a seed to randomly select one positive number that falls within the range from 1 to m(m−1)/2 and defines it as a cut selection value. Furthermore, the result obtained by adding this random value to the received simulation execution time is defined as target simulation time. The cut selection value and the target simulation time are paired up and sent as an authentication query.

The following Step 1102 and Step 1103 are executed in parallel at the supplier side and the OEM side, respectively.

### (Step 1102)

The key authentication program shares the authentication query with the query response program. When the authentication query is updated in Step 1101, the key authentication program uses the updated authentication query to calculate an expected value of a response query that is expected to be sent back from the OEM side. The binary counters that are incorporated in the key authentication program and used across simulators are operated up to the target simulation time and are stopped. Then, a value currently exchanged at the inter-simulator interface corresponding to the cut selection value is obtained. This value is temporarily stored as an expected value of the response query.

### (Step 1103)

When the query verifying program receives the authentication query, the query verifying program calculates a response query. The binary counters that are incorporated in the query verifying program and used across simulators are operated up to the target simulation time and are stopped. Then, a value currently exchanged at the inter-simulator interface corresponding to the cut selection value is obtained. This value is sent as a response query.

### (Step 3104)

When the key authentication program receives the response query sent from the query verifying program, the key authentication program compares the response-query expected value, which is calculated in advance in Step 1102, with the received response query and sends the result to the key transmitting and receiving part at the OEM side.

### (Step 1105)

When the key transmitting and receiving part receives the response-query comparison result, and, if the result shows agreement, the simulation Is continued, specifically, the flow returns to Step 1100. If the result shows disagreement or if the result has not been returned within a certain period of time, the virtual-computer abandoning command implemented in the virtual-environment operating agent is executed, thus forcibly stopping the simulation.

As described in detail above, the present invention can be applied to a computer system in which a plurality of software items are operated at high speed in conjunction with each other or a program for a development system. Then, for example, the virtual computer sent to the OEM side is operated only in a use condition set in advance by the supplies side, and the virtual computer currently executed is deleted when the condition is not satisfied, thereby making it possible to prevent abuse and replication of software resources.

Note that the present invention is not limited to the above-described embodiment and encompasses various modifications. For example, although the above-described embodiment has been described in detail for a better understanding of the present invention, the present invention is not necessarily limited to a system having all the described configurations. Furthermore, part of the configurations in the embodiment can be deleted or replaced with another configuration, or another configuration can be added. In addition, although a description has been given of the example case in which programs for realizing part or all of the above-described configurations, functions, and processing parts are generated, it is needless to say that part or all of them may be realized with hardware, for example, by designing part or all of them with integrated circuits.

### REFERENCE SINGS LIST

0100 . . . company-A computer environment
0101 . . . company-B computer environment
0102 . . . company-C computer environment
0103 . . . company-A software resource
0103b . . . company-B software resource
0103c . . . company-C software resource
0104 . . . virtual-computer generating part
0105 . . . authentication-query verifying part
0107 . . . communication channel
0108 . . . virtual-environment operating agent
0110 . . . company-B virtual computer environment
0109 . . . company-C virtual computer environment
0111 . . . company-B software resource replica
0112 . . . company-C software resource replica
0113 . . . authentication-query generating part
0114 . . . simulation execution agent
0115 . . . internal network
0700 . . . supplier-side cooperative simulation
0701 . . . cooperative simulation in another virtual environment
0702 . . . inquiry-query generating program
0703 . . . query verifying program
0704 . . . inter-simulator interface
0706 . . . virtual-computer controller
0708 . . . simulation activating command
0709 . . . simulation stopping command
0710 . . . simulation-execution-time acquiring command
0712 . . . virtual-computer receiving part
0713 . . . virtual-computer activating command
0714 . . . virtual-computer abandoning command
0715 . . . key transmitting and receiving part
0800 . . . cooperative-simulation-execution-instruction transmitting and receiving part
0802 . . . cooperative-simulation-request receiving part
0803 . . . virtual-computer template introduced-software DB
0804 . . . virtual-computer template DB
0806 . . . virtual-computer template
0807 . . . key transmitting and receiving part
0808 . . . query response program
0809 . . . key authentication program
0810 . . . local-computer generating part
0811 . . . transmission-virtual-computer generating part
0812 . . . inquiry-query-generating-program generating part
0813 . . . query-verifying-program generating part
0814 . . . key-authentication-program generating part
0815 . . . query-response-program generating part
0816 . . . software-resource-use-hash generating part
0817 . . . virtual-computer selecting part
0818 . . . local virtual computer
0819 . . . key authentication program
0820 . . . query response program
0821 . . . key transmitting and receiving part
0900 . . . all software resources
0901 . . . software resource that is not used for certain cooperative simulation
0902 . . . software resource that is used for certain cooperative simulation
0903 . . . software resource that should be wasted at OEM side by this system
0904 . . . software resource that should be wasted at supplier side by this system
0905 . . . software resource that is consumed by authentication-query generating part
0906 . . . software that is consumed by authentication-query verifying part
1200 . . . computer
1201 . . . processor
1202 . . . controller
1203 . . . memory
1204 . . . accelerator
1205 . . . network interface

1. A computer system comprising:
a computer environment of a user A and a computer environment of a user B that are connected to each other via a communication channel and that each have a software resource,
wherein the computer environment of the user B sends a virtual computer environment that includes a replica of the software resource owned by the computer environment of the user B and a simulation model requested by the user A, to the computer environment of the user A, thereby realizing a cooperative simulation.

2. A computer system according to claim 1,
wherein the simulation model includes an authentication-query generating part that generates an authentication key based on an execution state of the cooperative simulation executed in the computer environment of the user A and a usage situation of the replica of the software resource of the user B and that sends the generated authentication key to the user B; and
the computer environment of the user B includes an authentication-query verifying part that verifies the authentication key sent from the authentication-query generating part of the user A based on a usage situation of the software resource that the user B permits the user A to use.

3. A computer system according to claim 2, wherein the computer environment of the user A destructs the virtual computer environment, stops the cooperative simulation, and deletes the cooperative simulation from the computer environment of the user A, when it is determined that the user A abuses the software resource of the user B.

4. A computer system according to claim 2, wherein the authentication-query generating part of the user A generates the authentication key by using the replica of the software resource of the user B, the replica being not used for the cooperative simulation executed in the computer environment of the user A.

5. A computer system according to claim 2, wherein the authentication-query verifying part in the computer environment of the user B performs verification by using part or whole of the software resource of the user B, the part or the whole being used for the cooperative simulation executed in the computer environment of the user A.

6. A computer system comprising:
a network;
a computer environment of a user A that is connected to the network and that has a software resource; and
a computer environment of a user B that is connected to the network and that has a software resource,
wherein the computer environment of the user B includes a virtual-computer generating part that generates a virtual computer environment including a replica of the software resource owned by the computer environment of the user B and a simulation model that the user A requests from the user B; and
the computer environment of the user A executes a cooperative simulation by using the virtual computer environment received from the computer environment of the user B and the software resource of the user A.

7. A computer system according to claim 6,
wherein the computer environment of the user A receives, as the simulation model, an authentication-query generating part that generates an authentication key based on an execution state of the cooperative simulation executed in the computer environment of the user A and a usage situation of the replica of the software resource of the user B; and
the computer environment of the user B includes an authentication-query verifying part that verifies the authentication key sent from the authentication-query generating part operated in the computer environment of the user A, by using a usage situation of the software resource that the user B permits the user A to use.

8. A computer system according to claim 7, wherein the computer environment of the user A includes a virtual-environment operating agent that generates a destruction command for destructing the virtual computer environment when it is determined in the authentication-query verifying part that the user A abuses the software resource of the user B and deletes the cooperative simulation from the computer environment of the user A when the virtual-environment operating agent generates the destruction command.

9. A computer system according to claim 7, wherein the authentication-query generating part operated in the computer environment of the user A generates the authentication key by using the replica of the software resource of the user B, the replica being not used for the cooperative simulation executed in the computer environment of the user A.

10. A computer system according to claim 7 wherein the authentication-query verifying part operated in the computer environment of the user B performs verification by using part or whole of the software resource of the user B, the part or the whole being used for the cooperative simulation executed in the computer environment of the user A.

11. A program that is executed in a computer environment, the program comprising:
in a computer environment of a user A,
receiving, via a network, a virtual computer environment that includes a replica of a software resource of a user B and a simulation model that the user A requests from the user B;
executing a cooperative simulation by using the virtual computer environment and a software resource of the user A; and
generating an authentication key by using an execution state of the cooperative simulation executed in the computer environment of the user A and a usage situation of the replica of the software resource of the user B.

12. A program according to claim 11, comprising:
in the computer environment of the user A,
generating a destruction command for destructing the virtual computer environment when it is determined in a computer environment of the user B that the user A abuses the software resource of the user B; and
deleting the cooperative simulation from the computer environment of the user A according to the destruction command.

13. A program according to claim 11, comprising,
in the computer environment of the user A,
generating the authentication key by using the replica of the software resource of the user B, the replica being not used for the cooperative simulation executed in the computer environment of the user A.

14. A program according to claim 11, comprising:
in the computer environment of the user B,
receiving the authentication key sent from the computer environment of the user A; and
using a usage situation of the software resource that the user B permits the user A to use, thereby verifying the authentication key.

15. A program according to claim 14, comprising:
in the computer environment of the user B, performing verification by using part or whole of the software resource of the user B, the part or the whole being used for the cooperative simulation executed in the computer environment of the user A.
